(19) United States
(12) Patent Application Publication
(10) Pub. No.: US 2007/0221629 A1
(43) Pub. Date: Sep. 27, 2007

(54) Resistance spot welding system and method

(76) Inventors: Vernon Fernandez, Rochester Hills, MI (US); Manohar Das, Rochester Hills, MI (US); James W. Strausbaugh, Clarkston, MI (US); Gerald A. Grzadzinski, Sterling Heights, MI (US)

Correspondence Address: DAIMLERCHRYSLER INTELLECTUAL CAPITAL CORPORATION;CIMS 483-02-19, 800 CHRYSLER DR EAST, AUBURN HILLS, MI, 48326-2757, US

(21) Appl. No.: 11/386,910

(22) Filed: Mar. 22, 2006

(51) Int. Cl. B23K 11/24

(52) U.S. Cl. 219/110

(57) ABSTRACT

A method and system for controlling a welding system collects material thickness data and material type data for a plurality of materials to be welded. A non-linear power profile is generated having a discrete stepped approximation of power over a period of time based on the material thickness data and the material type data to produce a desired current amount at a specific time during welding of the plurality of materials.

### FIELD

The present disclosure relates to resistance spot welding. More specifically, this disclosure relates to a resistance spot welding controller with a non-linear power profile that produces a robust welding process.

### BACKGROUND

The statements in this section merely provide background information related to the present disclosure and may not constitute prior art.

In a resistance spot welding process, a pair of electrodes, using a predetermined force, clamps at least two pieces of materials together and cause current flow from the electrode tips through the pieces of materials. As the current flows and heats the pieces of materials, the materials heat up to their inherent melting point at the point where the materials are forged together and a weld is formed.

Previously, the process of welding the two pieces of material utilized control methods that included constant current, constant voltage, constant heat, and other methods. In the constant voltage and constant current method, the voltage or current are kept constant and a large amount of heat is supplied to the weld zone without consideration of expulsion or the actual energy need of the process. In the constant heat method, a linear power curve controls the welding process, which reduces the probability of expulsion, but it cannot be optimized for a high nugget diameter to energy ratio due to nonlinear dynamical characteristics of the welding process. Therefore, a method and a system having a resistance spot welding controller that utilizes a power curve with non-linear characteristics is needed to control a welding process to maximize a nugget diameter to energy ratio.

### SUMMARY

A method for controlling a welding system includes inputting thickness data and material type data of a plurality of materials being welded using the welding system. The method further includes generating a non-linear power profile having a discrete stepped approximation of power over a period of time based on the material thickness data and the material type data to produce a desired current amount at a specific time to weld the plurality of materials. After determining the desired current amount, the method includes transmitting the desired current amount to form a weld nugget within the plurality of materials being welded.

A resistance spot welding system includes a user input device configured to allow a user to input material type data and material thickness data for a plurality of materials being welded using the welding system. The system also includes a controller coupled to the user input device. The controller generates a non-linear power profile over a period of time based on the material thickness data and the material type data to produce and transmit a desired current amount at a specific time to weld the plurality of materials. Additionally, the system includes a pair of electrodes coupled to the controller. The pair of electrodes receives the desired current and forms a weld nugget within the plurality of materials being welded using the desired current.

### BRIEF DESCRIPTION OF THE DRAWINGS

The drawings described herein are for illustration purposes only and are not intended to limit the scope of the present disclosure in any way.

FIG. 1 is a flow chart illustrating a method for controlling a resistant spot welding system in accordance with the present disclosure;

FIG. 2 is a block diagram of a resistance spot welding system in accordance with the principles of the disclosure;

FIG. 3 is a graph illustrating an example of an exponentially decaying power curve along with discrete approximation of power; and

FIG. 4 is a graph illustrating an example of a dynamic resistance curve.

### DETAILED DESCRIPTION

The following description is merely exemplary in nature and is not intended to limit the present disclosure, application, or uses. It should be understood that throughout the drawings, corresponding reference numerals indicate like or corresponding parts and features.

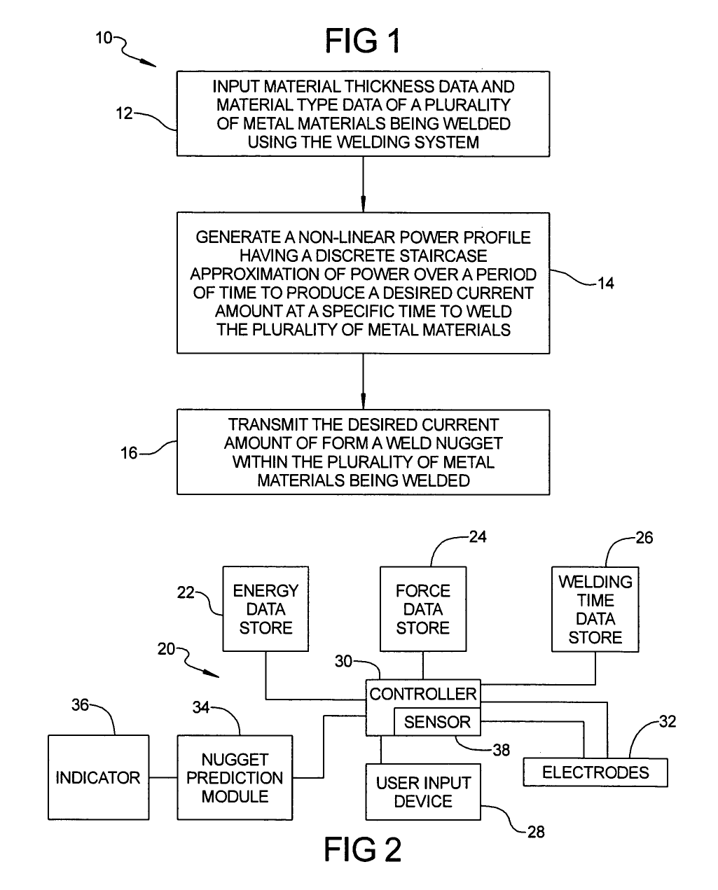

FIG. 1 illustrates a method 10 for controlling a welding system. The method 10 includes inputting material thickness data and material type data of a plurality of materials being welded using the welding system at step 12. Upon receiving the material thickness data and the material type data, a non-linear power profile having a discrete stepped approximation of power levels over a period of time is generated at step 14. The non-linear power profile is used to produce a desired current amount during that period to weld the plurality of materials. At step 16, the desired current is transmitted to form a weld nugget within the plurality of materials being welded. Steps 14 and 16 are repeated as many times as required by the discrete approximation.

An exemplary resistance spot welding system 20 is further described in relation to FIG. 2. The system 20 includes an energy data store 22, a force data store 24, a welding time data store 26, a user input device 28, a controller 30, a pair of electrodes 32, a nugget prediction module 34, and an indicator 36. In a preferred embodiment, the user input device 28 is coupled to the controller 30. Each of the energy data store 22, the force data store 24, and the welding time data store 26 are also coupled to the controller 30. The controller 30 is, in turn, coupled to the pair of electrodes 32. The nugget prediction module 34 is also coupled to the controller 30. The nugget prediction module 34 is, in turn, coupled to the indicator 36.

Additionally, the controller 30 may be implemented with a computer-processing unit (not shown), wherein each of the energy data store 22, the force data store 24, and the welding time data store 26 may be combined in a memory of the computer-processing unit.

The user input device 28 is configured to allow a user to input material type data and material thickness data for a plurality of materials being welded using the welding system 20. The user input device 28 operably transmits the material type data and the material thickness data to the controller 30.

Each material type data includes a material type identifier. The material type data is indicative of a type of material relating to the plurality of materials being welded using the welding system 20. Additionally, each material thickness data includes a welding material thickness identifier. The material thickness data is a combined thickness of each sheet within the plurality of materials.

The energy data store 22 stores a plurality of energy amount data in an associated look-up table. Each energy data is indicative of an optimal amount of energy needed to form an optimal weld nugget associated with a specific material type and a specific material thickness. Additionally, each energy data includes an energy amount, a material type identifier, and a material thickness.

The force data store 24 stores a plurality of force data in an associated look-up table. Each force data corresponds to a specific material type and a specific welding material thickness. Each force data includes a weld force used by the pair of electrodes to clamp the plurality of materials, a material type identifier, and a material thickness identifier.

The welding time data store 26 stores a plurality of welding time data in an associated look-up table. Each welding time data corresponds to a specific material type and a specific welding material thickness. Each welding time data includes a welding time, a welding time identifier, a material thickness identifier, and a material type identifier.

The controller 30 is configured to receive the material type data and the material thickness data from the user input device 28. The controller 30 determines a plurality of welding parameters used by the welding system 20 to weld the plurality of materials based on the material thickness data and the material type data. More specifically, the controller 30 operably retrieves an optimal amount of power, a force, and a welding time based on the material type data and the material thickness data from the energy data store 22, the force data store 24, and the welding time data store, respectfully. While the controller 30 retrieves the force and power from each associated data store, alternatively the controller 30 may include a parametric model to compute the force and power needed to weld the materials. Next, the controller 30 transmits the force and the welding time to the pair of electrodes 32.

The controller 30 utilizes a nonlinear power profile to deliver the optimal amount of energy to the weld nugget. One example of a nonlinear power profile is an exponentially decaying power curve, p(t), described by the equation,
p(t)=P₀e^{αt}, 0≦t≦T, Equation 1
where P₀ denotes the power to be delivered at the beginning of the weld, i.e., at t=0, α is the time constant that controls the rate of decay of p(t), and T is the duration during which the weld current is applied.

Referring to equation 2, E denotes the desired amount of energy to be delivered to the weld nugget. Equation 1 is integrated from 0 to T and equated to E to obtain
E=P₀(1−e^{-αT})/α Equation 2
or, P₀ is given by
P₀=αE/(1−e^{-α}T) Equation 3

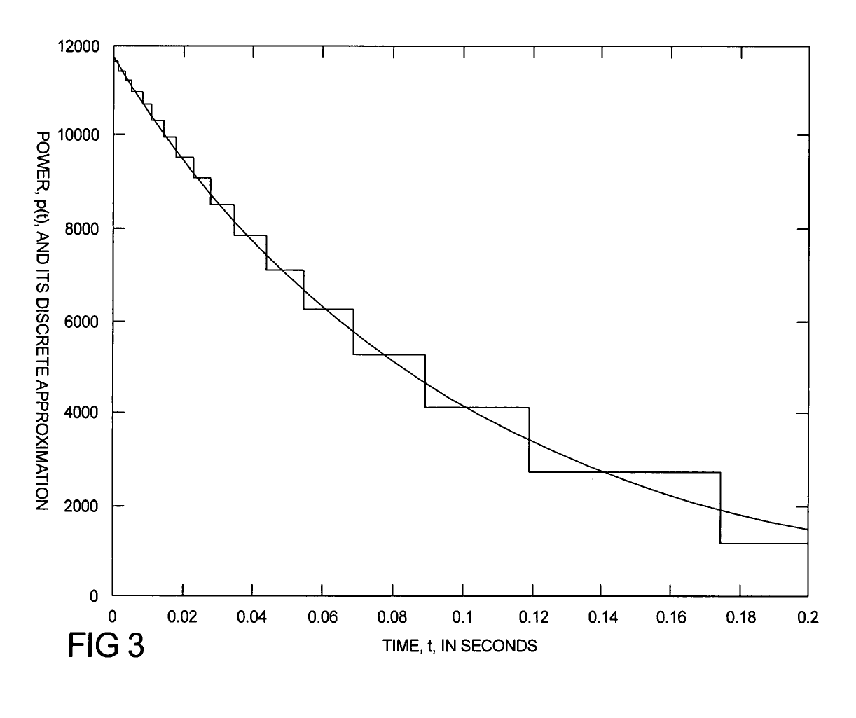

Energy E and the time constant a are known variables. Using equation 3, the controller 30 determines P₀ and thereby generates the desired power curve, p(t). The desired power curve p(t) is divided into discrete intervals of time to get a stepped approximation, as shown in FIG. 3. The stepped approximation consists of N time segments, the end points of which are denoted by the time instances, tₖ, 1≦k≦N, and corresponding N power levels, p(k), 1≦k≦N, i.e.,
p(k)=p(tₖ) Equation 4

Next, in order to follow the power curve, the controller 30 determines a desired current amount, i(t), according to the equation:
p(t)=i²(t)r(t), Equation 5
where r(t) denotes the dynamic resistance of the pieces placed between the welding electrodes.

The controller 30 also includes a plurality of sensors 38 adapted to be coupled to the pair of electrodes 32 for receipt of welding current and welding voltage. The controller 30 determines the dynamic resistance of the weld based on the welding current and the welding voltage. Additionally, the controller 34 transmits a signal of the dynamic resistance to the nugget prediction module 34. The nugget prediction module 34 is further discussed later.

The following equations illustrate how the controller 30 determines the dynamic resistance r(t) of the weld nugget. The voltage, v(t), measured across the plurality of materials can be modeled by:
v(t)=m(t)(di/dt)+r(t)i(t), Equation 6
where r(t) denotes the dynamic resistance of the plurality of materials, and the term m(t)(di/dt) represents a tip voltage induced in wires connected across the plurality of materials to measure v(t). This term occurs due to mutual inductance, m(t), between the wires and the pair of electrodes 32. Suppose the tip voltage mₖ and the dynamic resistance rₖ denote the values of m(t) and r(t) at time instance, tₖ. Also, the controller 30 collects M samples of v(t), i(t) and di/dt, denoted by vⱼ, iⱼ, and diⱼ, 1≦j≦M. Then equation 6 gives rise to the following set of simultaneous linear equations:
vⱼ=mₖ(diⱼ)+rₖiⱼ, 1≦j≦M, Equation 7
which can easily be solved using a least squares technique to obtain estimated values of the tip voltage mₖ and the dynamic resistance rₖ, at time instance, tₖ.

The controller 30 also assures that the total energy delivered to the weld nugget is equal to the desired energy, E, by continuously monitoring delivered energy to the nugget and adjusting the current amount for the last segment to compensate for any differences. More specifically, the controller 30 monitors an electrode current and tip voltage across the pair of electrodes 32 to determine the delivered energy.

Although an exponentially decaying power curve in FIG. 3 was chosen for the purpose of illustration, the algorithm presented above is quite general and can be easily adapted to any desired power profile. In fact, the controller 30 chooses different power profiles depending on the material type and the material thickness, since the optimal power and power profiles are different for each of a selected plurality of materials.

The pair of electrodes 32 is configured to receive the force and the welding time from the controller 30. Additionally, the pair of electrodes is configured to receive the desired current amount. Using the current amount, the force, and the welding time, the pair of electrodes welds the plurality of materials.

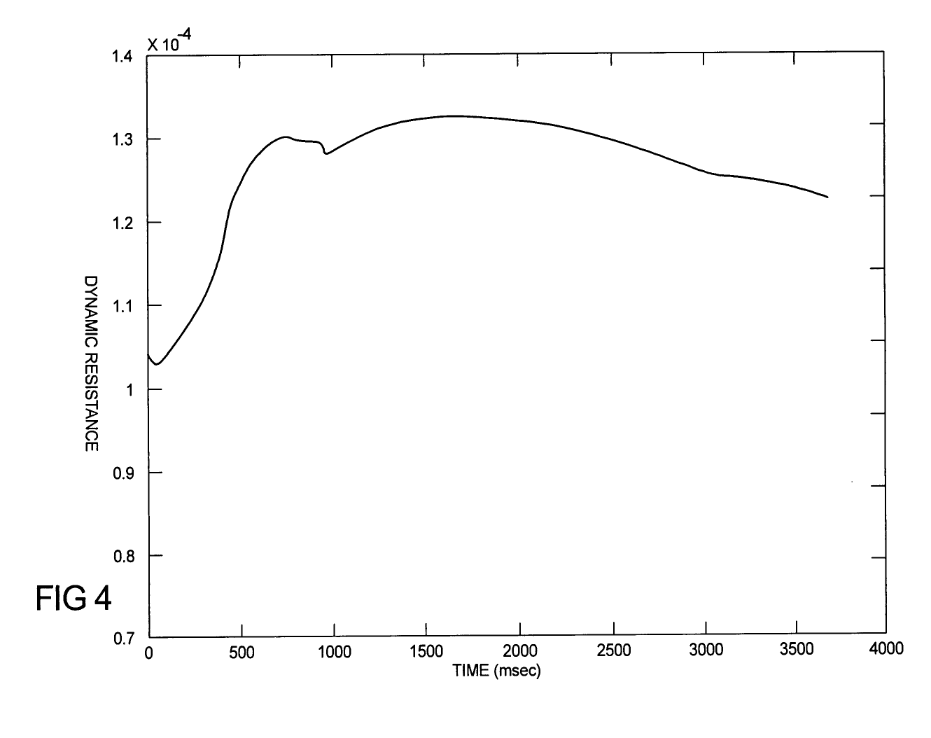

The nugget prediction module 34 estimates a nugget size of a weld nugget formed in a weld based on the dynamic resistance of the weld. The nugget prediction module 34 retrieves a dynamic resistance signal sent by the controller 30 to produce a dynamic resistance profile or curve. FIG. 4 discloses a typical dynamic resistance curve estimated during the weld time, i.e. the time of current flow. The dynamic resistance curve is characterized by three distinguished phases. At the beginning, the resistance increases from a minimum to a maximum value as the temperature rises. A first peak occurs when a surface coating of the materials melts. A next peak occurs as the materials start to melt. From this point onward the resistance starts to decrease mainly due to mechanical collapse of welded materials. Finally, the dynamic resistance curve reaches a steady state value during the holding time.

Additionally, the nugget prediction module 34 includes a pre-trained model to estimate the nugget size relating to the weld in real time. The pre-trained model may include either a linear or non-linear model. Additionally, the pre-trained model is generally trained using data gathered from a number of welds performed previously using different material type data and material thickness data. After the model is trained, the model is embedded in the nugget prediction module 34 for on-line estimation of the nugget size.

The nugget prediction module 34 extracts certain features derived from the dynamic resistance curve (recorded after completion of the weld) and determines the nugget size of the weld using the pre-trained model along with the material type data and the material thickness data. Extracted features from the dynamic resistance curve may include, but are not limited to: a maximum resistance, area under the dynamic resistance curve (from the beginning to the end of the weld time), a maximum rate of decay of curve after reaching the maximum resistance, and a steady state value of resistance reached during a hold time. The nugget prediction module 34 may also use other features in the pre-trained model, such as RMS current, force, the material type data, and the material thickness data. After estimating the nugget size, the nugget prediction module 34 sends a signal to the indicator 36 to alert the operator of the nugget size.

The indicator 36 is configured to receive an estimated nugget size signal from the nugget prediction module 34. The indicator 36 alerts the operator of an estimated nugget size for the weld. More specifically, the indicator 36 displays the estimated nugget size to an operator.

What is claimed is:

1. A method for controlling a welding system comprising:
collecting material thickness data and material type data of a plurality of materials to be welded using the welding system;
generating a non-linear power profile having a discrete stepped approximation of power over a period of time based on the material thickness data and the material type data to produce a desired current at a specific time to weld the plurality of materials; and
using the desired current to form a weld nugget within the plurality of materials being welded.

2. The method of claim 1, wherein generating the non-linear power profile comprises:
determining a desired power associated with the material thickness data and the material type data;
generating a desired power curve based on the desired power;
determining an amount of beginning power to be delivered at a beginning of a weld; and
reducing the amount of power over the period of time using a nonlinear rate of decay.

3. The method of claim 2, wherein the desired power curve further includes having an optimal power characteristic.

4. The method of claim 2, wherein the desired power curve further includes having an exponential decaying characteristic.

5. The method of claim 4, wherein the exponential decaying characteristic is based on
p(t)=P₀e^{-αt}, 0≦t≦T and
P₀=αE/(1−e^{-αT})
where p(t) is the exponential decaying power characteristic, P₀ denotes power to be delivered at the beginning of the weld, at t=0, α is a time constant that controls a rate of decay of p(t), E denotes the desired amount of energy to be delivered to the weld nugget and T is a duration during which a weld current is applied.

6. The method of claim 1, wherein the discrete stepped approximation is based on
p(k)=p(tₖ)
where the stepped approximation includes N time segments having end points of which are denoted by time instances, tₖ,1≦k≦N, and corresponding N power levels, p(k), 1≦k≦N.

7. The method of claim 1, wherein producing the desired current amount further comprises:
sensing a welding current and a welding voltage;
estimating dynamic resistance of the materials based on the welding current and the welding voltage;
determining the desired current amount based on the dynamic resistance for the specific time.

8. The method of claim 7, further comprising: determining a weld nugget size based on the dynamic resistance.

9. The method of claim 1, further comprising:
determining a plurality of welding parameters to be used by the welding system based on the material thickness data and the material type data.

10. The method of claim 9, wherein determining the plurality of welding parameters further comprises determining at least one welding parameter from an associated parameter look-up table.

11. The method of claim 9, wherein determining the plurality of welding parameters further comprises retrieving at least one welding parameter from an associated parametric model.

12. A resistance spot welding system comprising:
a user input device configured to allow a user to input material type data and material thickness data for a plurality of materials to be welded using;
a controller coupled to the user input device and operably generating a non-linear power profile over a period of time based on the material type data and the material thickness data to produce and transmit a desired current amount at a specific time to weld the plurality of materials; and
a pair of electrodes coupled to the controller and operably receiving the desired current to form a weld nugget within the plurality of materials being welded.

13. The system of claim 12, wherein the non-linear power profile further comprises a discrete stepped approximation of power.

14. The system of claim 13, wherein the discrete stepped approximation of power is based on
p(k)=p(tₖ)
where the stepped approximation includes N time segments having end points of which are denoted by time instances, tₖ, 1≦k≦N, and corresponding N power levels, p(k), 1≦k≦N.

15. The system of claim 12, wherein the controller is further configured to determine force, welding time and energy needed to weld the plurality of materials based on the material type and the welding material thickness.

16. The system of claim 12, further comprising:
wherein the controller includes a plurality of sensors adapted to be coupled to the pair of electrodes for receipt of welding current and welding voltage, the controller determines dynamic resistance of the weld based on the welding current and the welding voltage and transmits a signal of the dynamic resistance;
a nugget prediction module coupled to the controller and configured to receive the signal, wherein the nugget prediction module estimates a nugget size based on a dynamic resistance signal and generates a nugget size signal;
an indicator coupled to the nugget prediction module and configured to receive the nugget size signal, wherein the indicator displays an estimated nugget size to an operator.

17. The system of claim 12, wherein the desired nonlinear power curve further comprises an optimal power characteristic.

18. The system of claim 12, wherein the desired non-linear power curve further comprises an exponential decaying characteristic.

19. The system of claim 18, wherein the exponential decaying characteristic is based on
p(t)=P₀e^{-αt}, 0≦t≦T and
P₀=αE/(1−e^{-αT})
where p(t) is the exponential decaying power characteristic, P₀ denotes power to be delivered at a beginning of the weld, at t=0, a is a time constant that controls a rate of decay of p(t), E denotes the desired amount of energy to be delivered to the weld nugget and T is a duration during which a weld current is applied.

20. The system of claim 12, wherein the controller determines an amount of power to be delivered at a beginning of a weld and decreases power over the period of time.
